(19) United States
(12) Patent Application Publication
(10) Pub. No.: US 2011/0116426 A1
(43) Pub. Date: May 19, 2011

(54) CABLELESS USB CONNECTIVITY OVER IEEE 802.11 NETWORKS

(76) Inventors: Alexey Polonsky, Netanya (IL); Ophir Herbst, Herzliya (IL); Ilya Lifshits, Netanva (IL)

(21) Appl. No.: 13/054,496

(22) PCT Filed: Jul. 14, 2009
(86) PCT No.: PCT/IB09/53038

§ 371 Date: Jan. 16, 2011

Related U.S. Application Data
(60) Provisional application No. 61/081,587, filed on Jul. 17, 2008.

(51) Int. Cl. H04B 7/00

(52) U.S. Cl. 370/310

(57) ABSTRACT

Providing cableless USB connectivity to 802.11-enabled computing devices via 802.11 networks, including transmitting and receiving data in accordance with an 802.11 wireless communications protocol, maintaining a USB-protocol stack including USB-protocol data and control messages, adapting USB-protocol data and control messages in the USB-protocol stack for wireless transmission in accordance with an 802.11 wireless communications protocol, and providing to the USB-protocol stack USB-protocol data and control messages found within received 802.11-protocol communications.

### FIELD OF THE INVENTION

The invention relates to Universal Serial Bus (USB) technology and IEEE 802.11 networks in general, and more particularly to providing cableless USB connectivity via 802.11 networks.

### BACKGROUND OF THE INVENTION

The Universal Serial Bus (USB) standard is a widely-adopted system that enables electronic peripheral devices to communicate with host computing devices via physical cable links. The Wireless Universal Serial Bus (WUSB) standard provides extensions to the USB standard that enable the use of wireless links to connect peripheral and host devices. As WUSB relies on ultra-wide-band (UWB) wireless technology, peripheral and host computing devices require specialized hardware and software that support UWB communications. Although the vast majority of USB-enabled peripheral and host computing devices are not UWB-enabled, and thus cannot support WUSB connectivity, a large number of them are already capable of wireless communication in accordance with the IEEE 802.11 standard.

### SUMMARY OF THE INVENTION

The invention in embodiments thereof discloses novel systems and methods for providing cableless USB connectivity to 802.11-enabled peripherals and host computing devices via 802.11 networks.

In one aspect of the invention apparatus is provided for providing cableless USB connectivity to 802.11-enabled computing devices via 802.11 networks, including an 802.11 device communicator configured to transmit and receive data in accordance with an 802.11 wireless communications protocol, a USB protocol-stack configured to maintain USB-protocol data, and a USB/802.11 adapter configured to adapt USB-protocol data and control messages in the USB-protocol stack for wireless transmission by the 802.11 device communicator 802.110, and provide to the USB-protocol stack USB-protocol data and control messages found within 802.11-protocol communications received by the 802.11 device communicator.

In another aspect of the invention a system is provided for providing cableless USB connectivity to 802.11-enabled computing devices via 802.11 networks, the system including a host computing device including an 802.11 host communicator configured to transmit and receive data in accordance with an 802.11 wireless communications protocol, a USB host protocol stack configured to maintain USB-protocol data and control messages, and a USB/802.11 host adapter configured to adapt USB-protocol data and control messages in the USB host protocol stack for wireless transmission by the 802.11 host communicator 802.110, and provide to the USB host protocol stack USB-protocol data and control messages found within 802.11-protocol communications received by the 802.11 host communicator, and a peripheral computing device including an 802.11 device communicator configured to transmit and receive data in accordance with an 802.11 wireless communications protocol, a USB device protocol stack configured to maintain USB-protocol data and control messages, and a USB/802.11 device adapter configured to adapt USB-protocol data and control messages in the USB device protocol stack for wireless transmission by the 802.11 device communicator 802.110, and provide to the USB device protocol stack USB-protocol data and control messages found within 802.11-protocol communications received by the 802.11 device communicator.

In another aspect of the invention the USB/802.11 device adapter is configured to cause the 802.11 device communicator to advertise the peripheral computing device as being contention-free (CF) pollable.

In another aspect of the invention the USB/802.11 host adapter is configured to use the Point Coordinated Function (PCF) for Media Access Control (MAC) in an 802.11-protocol network.

In another aspect of the invention the USB/802.11 host adapter is configured to cause the 802.11 host communicator to wirelessly transmit USB-protocol information during either of contention free periods (CFP) and contention periods (CP).

In another aspect of the invention the USB/802.11 host adapter is configured to cause the 802.11 host communicator to wirelessly transmit USB control messages during a CP.

In another aspect of the invention the USB/802.11 host adapter is configured to act as point coordinator (PC) during a CFP.

In another aspect of the invention the USB/802.11 host adapter is configured to cause the 802.11 host communicator to wirelessly transmit during a CFP a beacon configured to identify a transmission channel carrying the beacon as USB-enabled, and at least one frame configured to include a USB-protocol out token, a USB-protocol in token, and USB-protocol data.

In another aspect of the invention the USB/802.11 device adapter is configured to cause the 802.11 device communicator to wirelessly transmit during a CFP a frame configured to include USB-protocol data and a USB-protocol out-acknowledgement token, where the frame is transmitted subsequent to the USB/802.11 device adapter receiving a USB-protocol polling message from the USB/802.11 host adapter.

In another aspect of the invention the USB/802.11 host adapter is configured to cause the 802.11 host communicator to wirelessly transmit during a CFP a CF data frame together with a USB-protocol in-acknowledgement token, where the frame is transmitted subsequent to the USB/802.11 host adapter receiving USB-protocol data from the USB/802.11 device adapter.

In another aspect of the invention the USB/802.11 host adapter is configured to reserve a number of service time slots (STS) during a CFP, where the STS encapsulates a portion of data from an isochronous data stream.

In another aspect of the invention a method is provided for providing cableless USB connectivity to 802.11-enabled computing devices via 802.11 networks, the method including transmitting and receiving data in accordance with an 802.11 wireless communications protocol, maintaining a USB-protocol stack including USB-protocol data and control messages, adapting USB-protocol data and control messages in the USB-protocol stack for wireless transmission in accordance with an 802.11 wireless communications protocol, and providing to the USB-protocol stack USB-protocol data and control messages found within received 802.11-protocol communications.

In another aspect of the invention a method is provided for providing cableless USB connectivity to 802.11-enabled computing devices via 802.11 networks, the method including configuring a first computing device to include each of a first 802.11 communicator configured to transmit and receive data in accordance with an 802.11 wireless communications protocol, a first USB protocol stack configured to maintain USB-protocol data and control messages, and a first USB/802.11 adapter configured to adapt USB-protocol data and control messages in the first USB protocol stack for wireless transmission by the first 802.11 communicator 802.110, and provide to the first USB protocol stack USB-protocol data and control messages found within 802.11-protocol communications received by the first 802.11 communicator, and configuring the first computing device for communications with a second computing device including a second 802.11 communicator configured to transmit and receive data in accordance with an 802.11 wireless communications protocol, a second USB protocol stack configured to maintain USB-protocol data and control messages, and a second USB/802.11 adapter configured to adapt USB-protocol data and control messages in the second USB protocol stack for wireless transmission by the second 802.11 communicator 802.110, and provide to the second USB protocol stack USB-protocol data and control messages found within 802.11-protocol communications received by the first 802.11 communicator.

In another aspect of the invention the method further includes configuring the first USB/802.11 adapter to use the Point Coordinated Function (PCF) for Media Access Control (MAC) in an 802.11-protocol network.

In another aspect of the invention the method further includes configuring the first USB/802.11 adapter to cause the first 802.11 communicator to wirelessly transmit USB-protocol information during either of contention free periods (CFP) and contention periods (CP).

In another aspect of the invention the method further includes configuring the first USB/802.11 adapter to cause the first 802.11 communicator to wirelessly transmit USB control messages during a CP.

In another aspect of the invention the method further includes configuring the first USB/802.11 adapter to act as point coordinator (PC) during a CFP.

In another aspect of the invention the method further includes configuring the first USB/802.11 adapter to cause the first 802.11 communicator to wirelessly transmit during a CFP a beacon configured to identify a transmission channel carrying the beacon as USB-enabled, and at least one frame configured to include a USB-protocol out token, a USB-protocol in token, and USB-protocol data.

In another aspect of the invention the method further includes configuring the USB/802.11 device adapter to cause the 802.11 device communicator to wirelessly transmit during a CFP a frame configured to include USB-protocol data and a USB-protocol out-acknowledgement token, where the frame is transmitted subsequent to the second USB/802.11 adapter receiving a USB-protocol polling message from the first USB/8020.11 adapter.

In another aspect of the invention the method further includes configuring the first USB/802.11 adapter to cause the first 802.11 communicator to wirelessly transmit during a CFP a CF data frame together with a USB-protocol in-acknowledgement token, where the frame is transmitted subsequent to the first USB/802.11 adapter receiving USB-protocol data and control messages from the second USB/802.11 adapter.

In another aspect of the invention the method further includes configuring the first USB/802.11 adapter to reserve a number of service time slots (STS) during a CFP, where the STS encapsulates a portion of data from an isochronous data stream.

In another aspect of the invention a computer program product is provided for providing cableless USB connectivity to 802.11-enabled computing devices via 802.11 networks, the computer program product including a computer readable medium, and computer program instructions operative to transmit and receive data in accordance with an 802.11 wireless communications protocol, maintain a USB-protocol stack including USB-protocol data and control messages, adapt USB-protocol data and control messages in the USB-protocol stack for wireless transmission in accordance with an 802.11 wireless communications protocol, and provide to the USB-protocol stack USB-protocol data and control messages found within received 802.11-protocol communications, where the program instructions are stored on the computer readable medium.

### BRIEF DESCRIPTION OF THE DRAWINGS

The invention will be understood and appreciated more fully from the following detailed description taken in conjunction with the appended drawings in which:

FIG. 1 is a simplified conceptual illustration of a system for providing cableless USB connectivity to 802.11-enabled peripheral and host computing devices via 802.11 networks, constructed and operative in accordance with an embodiment of the invention;

FIG. 2 is a simplified conceptual illustration of 802.11-protocol communications carrying non-isochronous USB-protocol payloads, constructed and operative in accordance with an embodiment of the invention;

FIG. 3 is a simplified conceptual illustration showing an exemplary CFP of an 802.11-protocol communication encapsulating USB-protocol data and control messages during non-isochronous USB communications, constructed and operative in accordance with an embodiment of the invention;

FIG. 4 is a simplified conceptual illustration of 802.11-protocol communications carrying isochronous USB-protocol payloads, constructed and operative in accordance with an embodiment of the invention; and

FIG. 5 is a simplified block diagram of an exemplary hardware implementation of a computing system in accordance an embodiment of the invention.

### DETAILED DESCRIPTION OF THE INVENTION

The invention is now described within the context of one or more embodiments, although the description is intended to be illustrative of the invention as a whole, and is not to be construed as limiting the invention to the embodiments shown. It is appreciated that various modifications may occur to those skilled in the art that, while not specifically shown herein, are nevertheless within the true spirit and scope of the invention.

As will be appreciated by one skilled in the art, the invention may be embodied as a system, method or computer program product. Accordingly, the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to any physically tangible device that operates using electronic, magnetic, optical, electromagnetic, or semiconductor physical components. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any physically tangible medium that can contain, store, communicate, propagate, or transport the program for use by or in connection with the instruction execution system, apparatus, or device.

Computer program code for carrying out operations of the invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

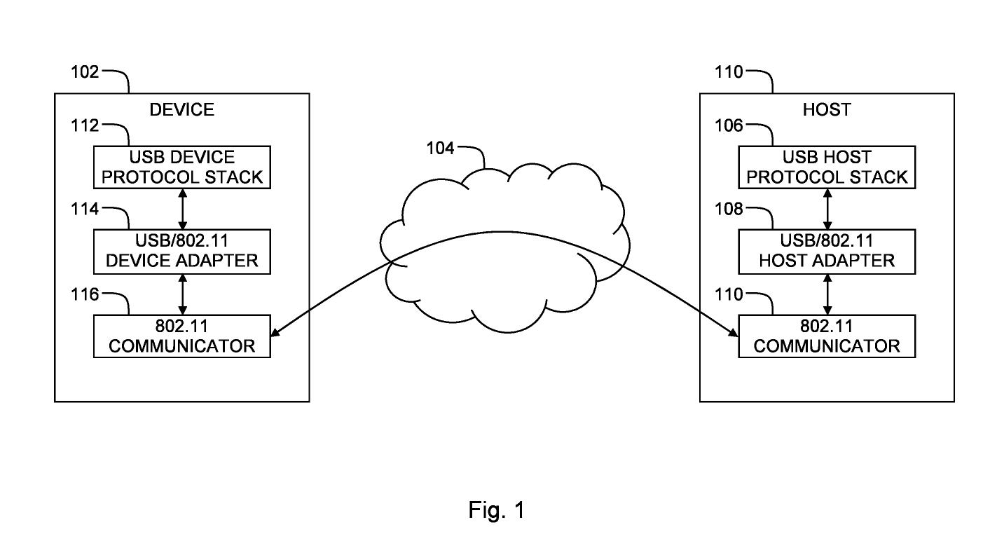

Reference is now made to FIG. 1 which is a simplified conceptual illustration of a system for providing cableless USB connectivity to 802.11-enabled peripheral and host computing devices via 802.11 networks, constructed and operative in accordance with an embodiment of the invention. In the system of FIG. 1, a host computing device 100 communicates wirelessly with one or more peripheral computing devices 102 via a network 104. Host 100 includes a USB host protocol stack 106 for maintaining USB-protocol data and control messages, such as are received by or received from a USB/802.11 host adapter 108. USB/802.11 host adapter 108 adapts USB-protocol data and control messages received from USB protocol stack 106 for transmission by an 802.11 communicator 110 to device 102. When 802.11 communicator 110 receives a transmission from any device 102, USB/802.11 host adapter 108 inspects the transmission to determine if it includes a USB-protocol payload, which USB/802.11 host adapter 108 then conveys to USB host protocol stack 106.

Similarly, each device 102 includes a USB device protocol stack 112 for maintaining USB-protocol data and control messages, such as are received by or received from a USB/802.11 device adapter 114. USB/802.11 host adapter 114 adapts USB-protocol data and control messages received from USB device protocol stack 112 for transmission by an 802.11 communicator 116 to host 100. When 802.11 communicator 116 receives a transmission from host 100, USB/802.11 device adapter 114 inspects the transmission to determine if it includes a USB-protocol payload, which USB/802.11 device adapter 114 then conveys to USB device protocol stack 112. Each device adapter 114 preferably causes its 802.11 communicator 116 to advertise the device as contention-free (CF) pollable.

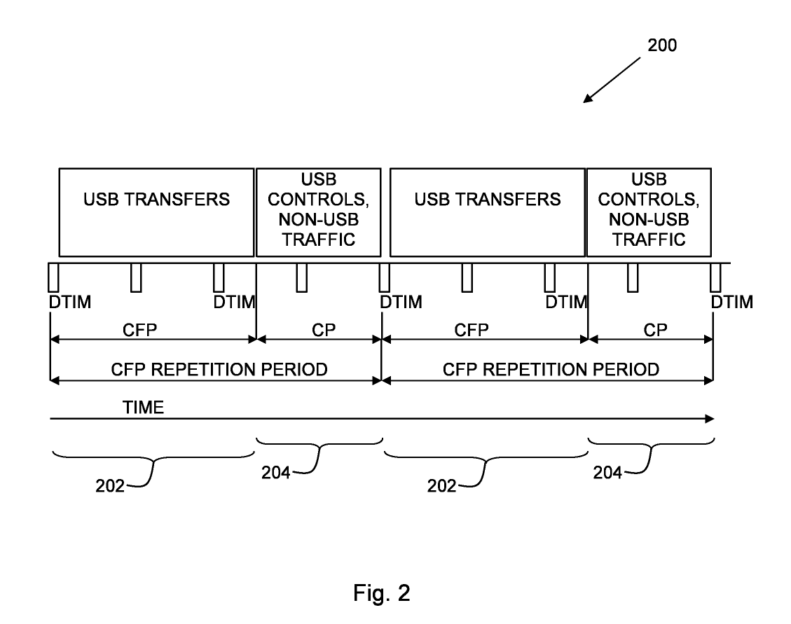

Additional reference is now made to FIG. 2, which is a simplified conceptual illustration of 802.11-protocol communications carrying non-isochronous USB-protocol payloads, constructed and operative in accordance with an embodiment of the invention. Host adapter 108 (FIG. 1) preferably uses the Point Coordinated Function (PCF) for Media Access Control (MAC) in an 802.11-protocol network. Thus, in FIG. 2, a time segment of a communications channel, generally designated 200, is divided into a sequence of contention free periods (CFP) 202 and contention periods (CP) 204. During each CP 204, host adapter 108 and each device adapter 114, via their respective 802.11 communicators 110 and 116, preferably compete with each other, and with other 802.11-enabled devices that are not USB-enabled but that may share the same 802.11 network, for access to channel 200, such as for transmitting USB-protocol control messages, preferably utilizing a random back-off protocol to decrease the probability of collisions. During each CFP 202, USB host adapter 108 preferably acts as point coordinator (PC) and gains complete control over channel 200 traffic, such as for transmitting data/management frames or polling device 102 and any other USB-enabled devices for data. The PC determines the repetition period and the length of the CFP's in accordance with conventional techniques. The repetition period is preferably synchronized with beacons and is an integer multiple of a Delivery Traffic Indication Message (DTIM) period, which itself is preferably an integer multiple of the beacon period.

Host control messages, such as messages relating to channel management, acknowledgments of device notifications, and hardware-related events such as reset and power on/off, are preferably transmitted during either CFP 202 or CP 204. Device-transmitted notifications, such as acknowledgements of host control messages, and hardware-related events such as connect/disconnect and remote wake up, are preferably transmitted during CFP 202, such as when device 102 is polled by host 100, or during CP 204. All other types of USB messages are preferably encapsulated in contention-free (CF) data frames which are transmitted during CFP 202.

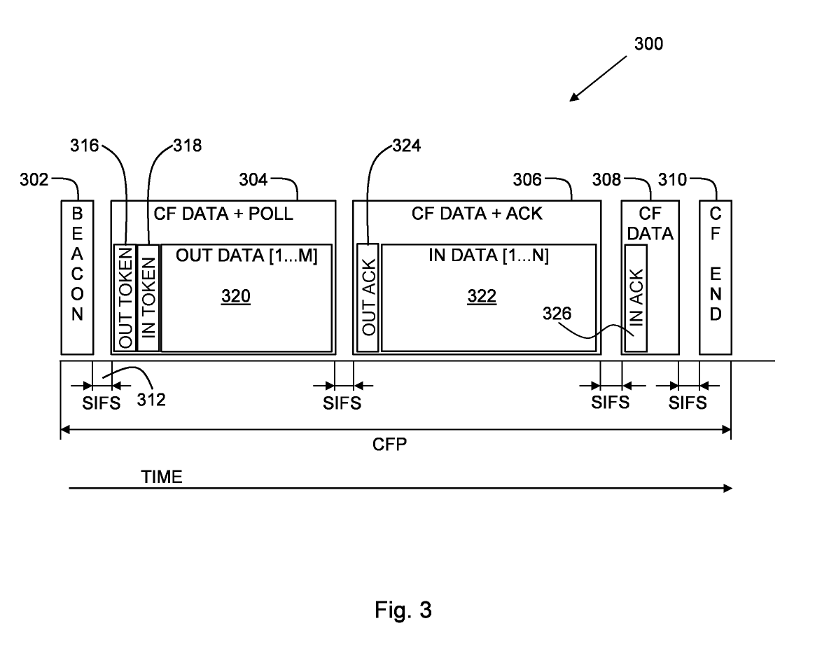

Additional reference is now made to FIG. 3, which is a simplified conceptual illustration showing an exemplary CFP of an 802.11-protocol communication encapsulating USB-protocol data and control messages during non-isochronous USB communications, constructed and operative in accordance with an embodiment of the invention. In FIG. 3, a CFP, generally designated 300, is shown including a beacon 302 that is preferably transmitted at the beginning of each CFP 300, followed by frames 304, 306, and 308, that are transmitted during CFP 300 after beacon 302, and a CF End frame 310 announcing the end of each CFP 300, where beacons 302, frames 304, 306, and 308, and CF End frame 310 are preferably separated by short interframe spaces 312.

Host adapter 108 preferably supports inbound frame traffic, preferably maintaining a CF polling list which is used to select stations that will be polled during CFPs. Host adapter 108 transmits beacon 302 via 802.11 communicator 110, where beacon 302 is preferably configured to identify the channel as USB-enabled and advertise USB-related parameters of the physical channel, such as by providing such information using vendor-specific information elements (IE's) that are transmitted within 802.11 beacon frames. Beacon 302 is received by 802.11 communicator 116 at device 102, whereupon any USB-related information it carries that may be required by USB-enabled applications that are present on device 102 is forwarded by device adapter 114 to USB device protocol stack 112.

After transmitting beacon 302, host adapter 108 transmits frame 304 via 802.11 communicator 110, or a sequence of multiple frames 304, where each frame 304 is configured to include a USB-protocol out token 316, a USB-protocol in token 318, and USB-protocol data 320, such data being normally provided by USB host protocol stack 106 during communication with devices 102. Frame 304 is received by 802.11 communicator 116 at device 102, whereupon its USB-protocol tokens and data payload are forwarded by device adapter 114 to USB device protocol stack 112.

After being polled by USB/802.11 host adapter 108, USB/802.11 device adapter 114 responds as necessary in accordance with USB protocol. The response is encapsulated by device adapter 114 into frame 306 as data 322 together with a USB-protocol out-acknowledgement token 324. Device adapter 114 then transmits frame 306 via 802.11 communicator 116. Frame 306 is received by 802.11 communicator 110 at host 100, whereupon its USB-protocol tokens and data payload are forwarded by host adapter 108 to USB host protocol stack 106.

After receiving data from USB device protocol stack 112, host adapter 108 transmits CF data frame 308 via 802.11 communicator 110 together with a USB-protocol in-acknowledgement token 326. CF data frame 308 is received by 802.11 communicator 116 at device 102, whereupon in-acknowledgement token 326 is forwarded by device adapter 114 to USB device protocol stack 112.

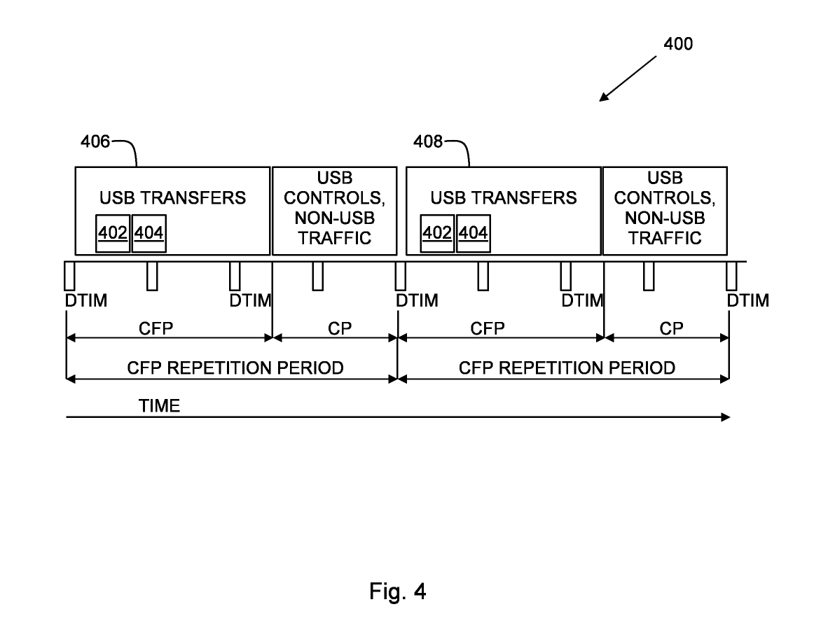

Additional reference is now made to FIG. 4, which is a simplified conceptual illustration of 802.11-protocol communications carrying isochronous USB-protocol payloads, constructed and operative in accordance with an embodiment of the invention. In FIG. 4 a time segment of a communications channel, generally designated 400, is substantially similar to time segment 200 of FIG. 2, with the notable exception that when USB host protocol stack 106 attempts to open an isochronous pipe, host adapter 108 preferably reserves one or more dedicated service time slots (STS) during each CFP, such as slots 402 and 404, within CFPs 406 and 408, where for each isochronous data stream, a portion of the stream data are encapsulated into an STS of one CFP, while the next portion of the stream data are encapsulated into the same STS of the next CFP, and so on. The management of STSs, including setting their duration and repetition rate, is preferably such that the requirements of the isochronous data transfer are fulfilled, such as to provide a guaranteed bandwidth for transaction attempts with bounded latency, a guaranteed average constant data rate, and/or guaranteed retries during the service period if delivery failures occur.

It will be appreciated that the invention as described herein may be used to connect device 102 to host 100 without the use of a USB cable, not only allowing for USB-protocol data and control messages to be transferred wirelessly between USB host protocol stack 106 and USB device protocol stack 112, but also allowing device 102 and host 100 to function in accordance with USB protocol as they normally would do were device 102 to be connected to host 100 via a standard USB cable. Thus, any data in USB device protocol stack 112 that would normally be destined for transmission via a USB cable is intercepted or otherwise received by device adapter 114 and adapted for transmission via 802.11 CFP or CP frames as described hereinabove, and all 802.11 CFP or CP frames received by device 102 may be examined by device adapter 114 to determine whether they include USB-protocol control messages or data that are to be passed to USB device protocol stack 112 as if they were received via USB cable. Likewise, any data in USB host protocol stack 106 that would normally be destined for transmission via a USB cable is intercepted or otherwise received by host adapter 108 and adapted for transmission via 802.11 CFP or CP frames as described hereinabove, and all 802.11 CFP or CP frames received by host 100 may be examined by host adapter 108 to determine whether they include USB-protocol control messages or data that are to be passed to USB host protocol stack 106 as if they were received via USB cable. Furthermore, host adapter 108 and device adapter 114 preferably perform any actions as may be required to maintain an 802.11 wireless connection between host 100 and device 102 and in accordance with 802.11 standards.

It will be appreciated that any aspect of the invention described hereinabove may be implemented as a computer program product embodied in a computer-readable medium, such as in the form of computer program instructions stored on magnetic or optical storage media or embedded within computer hardware, and may be executed by or otherwise be made accessible to a computer.

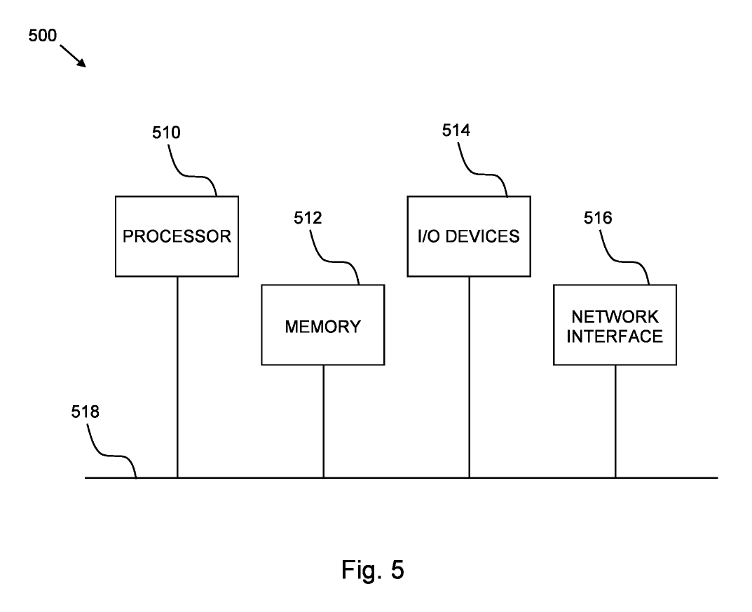

Referring now to FIG. 5, block diagram 500 illustrates an exemplary hardware implementation of a computing system in accordance with which one or more components/methodologies of the invention (e.g., components/methodologies described in the context of FIGS. 1-4) may be implemented, according to an embodiment of the invention.

As shown, the techniques for controlling access to at least one resource may be implemented in accordance with a processor 510, a memory 512, I/O devices 514, and a network interface 516, coupled via a computer bus 518 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The flowchart and block diagrams in the Figures illustrate the architecture, functionality, and operation of possible implementations of systems, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the methods and apparatus herein may or may not have been described with reference to specific computer hardware or software, it is appreciated that the methods and apparatus described herein may be readily implemented in computer hardware or software using conventional techniques.

While the invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. Apparatus for providing cableless USB connectivity to 802.11-enabled computing devices via 802.11 networks, comprising:
an 802.11 device communicator configured to transmit and receive data in accordance with an 802.11 wireless communications protocol;
a USB protocol-stack configured to maintain USB-protocol data and control messages; and
a USB/802.11 adapter configured to
adapt USB-protocol data and control messages in said USB-protocol stack for wireless transmission by said 802.11 device communicator 110, and
provide to said USB-protocol stack USB-protocol data and control messages found within 802.11-protocol communications received by said 802.11 device communicator.

2. A system for providing cableless USB connectivity to 802.11-enabled computing devices via 802.11 networks, the system comprising:
a host computing device including
an 802.11 host communicator configured to transmit and receive data in accordance with an 802.11 wireless communications protocol,
a USB host protocol stack configured to maintain USB-protocol data and control messages, and
a USB/802.11 host adapter configured to
adapt USB-protocol data and control messages in said USB host protocol stack for wireless transmission by said 802.11 host communicator 110, and
provide to said USB host protocol stack USB-protocol data and control messages found within 802.11-protocol communications received by said 802.11 host communicator; and
a peripheral computing device including
an 802.11 device communicator configured to transmit and receive data in accordance with an 802.11 wireless communications protocol,
a USB device protocol stack configured to maintain USB-protocol data and control messages, and
a USB/802.11 device adapter configured to
adapt USB-protocol data and control messages in said USB device protocol stack for wireless transmission by said 802.11 device communicator 110, and
provide to said USB device protocol stack USB-protocol data and control messages found within 802.11-protocol communications received by said 802.11 device communicator.

3. A system according to claim 2 wherein said USB/802.11 device adapter is configured to cause said 802.11 device communicator to advertise said peripheral computing device as being contention-free (CF) pollable.

4. A system according to claim 2 wherein said USB/802.11 host adapter is configured to use the Point Coordinated Function (PCF) for Media Access Control (MAC) in an 802.11-protocol network.

5. A system according to claim 2 wherein said USB/802.11 host adapter is configured to cause said 802.11 host communicator to wirelessly transmit USB-protocol information during either of contention free periods (CFP) and contention periods (CP).

6. A system according to claim 5 wherein said USB/802.11 host adapter is configured to cause said 802.11 host communicator to wirelessly transmit USB control messages during a CP.

7. A system according to claim 5 wherein said USB/802.11 host adapter is configured to act as point coordinator (PC) during a CFP.

8. A system according to claim 2 wherein said USB/802.11 host adapter is configured to cause said 802.11 host communicator to wirelessly transmit during a CFP
a beacon configured to identify a transmission channel carrying said beacon as USB-enabled, and
at least one frame configured to include a USB-protocol out token, a USB-protocol in token, and USB-protocol data.

9. A system according to claim 2 wherein said USB/802.11 device adapter is configured to cause said 802.11 device communicator to wirelessly transmit during a CFP a frame configured to include USB-protocol data and a USB-protocol out-acknowledgement token, wherein said frame is transmitted subsequent to said USB/802.11 device adapter receiving a USB-protocol polling message from said USB/802.11 host adapter.

10. A system according to claim 2 wherein said USB/802.11 host adapter is configured to cause said 802.11 host communicator to wirelessly transmit during a CFP a CF data frame together with a USB-protocol in-acknowledgement token, wherein said frame is transmitted subsequent to said USB/802.11 host adapter receiving USB-protocol data and control messages from said USB/802.11 device adapter.

11. A system according to claim 2 wherein said USB/802.11 host adapter is configured to reserve a plurality of service time slots (STS) during a CFP, wherein said STS encapsulates a portion of data from an isochronous data stream.

12. A method for providing cableless USB connectivity to 802.11-enabled computing devices via 802.11 networks, the method comprising:
transmitting and receiving data in accordance with an 802.11 wireless communications protocol;
maintaining a USB-protocol stack including USB-protocol data and control messages;
adapting USB-protocol data and control messages in said USB-protocol stack for wireless transmission in accordance with an 802.11 wireless communications protocol; and
providing to said USB-protocol stack USB-protocol data and control messages found within received 802.11-protocol communications.

13. A method for providing cableless USB connectivity to 802.11-enabled computing devices via 802.11 networks, the method comprising:
configuring a first computing device to include each of
a first 802.11 communicator configured to transmit and receive data in accordance with an 802.11 wireless communications protocol,
a first USB protocol stack configured to maintain USB-protocol data and control messages, and
a first USB/802.11 adapter configured to
adapt USB-protocol data and control messages in said first USB protocol stack for wireless transmission by said first 802.11 communicator 110, and
provide to said first USB protocol stack USB-protocol data and control messages found within 802.11-protocol communications received by said first 802.11 communicator; and
configuring said first computing device for communications with a second computing device including
a second 802.11 communicator configured to transmit and receive data in accordance with an 802.11 wireless communications protocol,
a second USB protocol stack configured to maintain USB-protocol data and control messages, and
a second USB/802.11 adapter configured to
adapt USB-protocol data and control messages in said second USB protocol stack for wireless transmission by said second 802.11 communicator 110, and
provide to said second USB protocol stack USB-protocol data and control messages found within 802.11-protocol communications received by said first 802.11 communicator.

15. A method according to claim 13 and further comprising configuring said first USB/802.11 adapter to use the Point Coordinated Function (PCF) for Media Access Control (MAC) in an 802.11-protocol network.

16. A method according to claim 13 and further comprising configuring said first USB/802.11 adapter to cause said first 802.11 communicator to wirelessly transmit USB-protocol information during either of contention free periods (CFP) and contention periods (CP).

17. A method according to claim 16 and further comprising configuring said first USB/802.11 adapter to cause said first 802.11 communicator to wirelessly transmit USB control messages during a CP.

18. A method according to claim 16 and further comprising configuring said first USB/802.11 adapter to act as point coordinator (PC) during a CFP.

19. A method according to claim 13 and further comprising configuring said first USB/802.11 adapter to cause said first 802.11 communicator to wirelessly transmit during a CFP
a beacon configured to identify a transmission channel carrying said beacon as USB-enabled, and
at least one frame configured to include a USB-protocol out token, a USB-protocol in token, and USB-protocol data.

20. A method according to claim 13 and further comprising configuring said USB/802.11 device adapter to cause said 802.11 device communicator to wirelessly transmit during a CFP a frame configured to include USB-protocol data and a USB-protocol out-acknowledgement token, wherein said frame is transmitted subsequent to said second USB/802.11 adapter receiving a USB-protocol polling message from said first USB/8020.11 adapter.

21. A method according to claim 13 and further comprising configuring said first USB/802.11 adapter to cause said first 802.11 communicator to wirelessly transmit during a CFP a CF data frame together with a USB-protocol in-acknowledgement token, wherein said frame is transmitted subsequent to said first USB/802.11 adapter receiving USB-protocol data and control messages from said second USB/802.11 adapter.

22. A method according to claim 13 and further comprising configuring said first USB/802.11 adapter to reserve a number of service time slots (STS) during a CFP, wherein said STS encapsulates a portion of data from an isochronous data stream.

23. A computer program product for providing cableless USB connectivity to 802.11-enabled computing devices via 802.11 networks, the computer program product comprising:
a computer readable medium; and
computer program instructions operative to
transmit and receive data in accordance with an 802.11 wireless communications protocol,
maintain a USB-protocol stack including USB-protocol data and control messages,
adapt USB-protocol data and control messages in said USB-protocol stack for wireless transmission in accordance with an 802.11 wireless communications protocol, and
provide to said USB-protocol stack USB-protocol data and control messages found within received 802.11-protocol communications,
wherein said program instructions are stored on said computer readable medium.
